(19) United States
(12) Patent Application Publication
(10) Pub. No.: US 2015/0029730 A1
(43) Pub. Date: Jan. 29, 2015

(54) LAMPSHADE

(71) Applicant: Ching-Hui CHEN, Huizhou City (CN)

(72) Inventor: Ching-Hui CHEN, Huizhou City (CN)

(21) Appl. No.: 14/215,007

(22) Filed: Mar. 16, 2014

(30) Foreign Application Priority Data
Jul. 25, 2013 (CN) 201320449457.1

(51) Int. Cl. F21V 1/06; F21V 17/10

(52) U.S. Cl. CPC F21V 1/06; F21V 17/108
USPC 362/352

(57) ABSTRACT

A lampshade, comprises an upper frame, a lower frame and a shade wall, wherein the upper frame is disposed on the lower frame; the upper frame and the lower frame are respectively encircled by at least three borders; positions of various borders in the upper frame and the lower frame correspond to each other respectively; the shade wall is rectangular, and is encircled on the outsides of the upper frame and the lower frame; upper edge portions and lower edge portions of various folded surfaces are respectively and correspondingly encircled on the outsides of various borders in the upper frame and the lower frame, and are respectively provided with extensions; velcro tapes are respectively disposed on inner surfaces of various extensions; magic stickers are disposed on inner side walls of various borders in the upper frame and the lower frame.

### FIELD OF THE INVENTION

The invention relates to a lampshade for illumination, in particular to a lampshade with the advantages of simple structure and convenient assembly.

### BACKGROUND OF THE INVENTION

The current commonly used household desk lamp shade structure is usually that: a lampshade support is disposed on the top or on a side surface of a desk lamp in advance at first, and hence a matching lampshade is sleeved on the lampshade support. The structure is very simple and convenient. The defects are that: the replacement of the lampshade is not convenient; and the lampshade must be carefully handled during the packing and the transportation. In particular, as for a glass lampshade, more attention should be paid during the transportation and use, or else, the lampshade may be dropped and broken.

### SUMMARY OF THE INVENTION

The technical problem to be solved by the invention is to provide a lampshade, in which the lampshade has a simple structure, is convenient to use, assemble and replace, and is a velcro tape lampshade which cannot break.

The invention may adopt the technical proposal that:

The invention discloses a lampshade, which comprises an upper frame, a lower frame and a shade wall, wherein the upper frame is disposed on the lower frame; the upper frame and the lower frame are respectively encircled by at least three borders; the size and the shape of the upper frame and the lower frame are same; positions of various borders in the upper frame and the lower frame correspond to each other respectively; the shade wall is rectangular, is folded to form folded surfaces of which the number is the same with that of the borders in the lower frame, and is encircled on the outsides of the upper frame and the lower frame; upper edge portions and lower edge portions of various folded surfaces are respectively and correspondingly encircled on the outsides of various borders in the upper frame and the lower frame, and are respectively provided with extensions; velcro tapes are respectively disposed on inner surfaces of various extensions; magic stickers are disposed on inner side walls of various borders in the upper frame and the lower frame; and after various extensions go around corresponding borders and are returned, the velcro tapes on respective inner surfaces are connected with the magic stickers disposed on the corresponding borders.

In order to solve the problem, the invention may further adopt the following improved measures:

Extensions formed on two adjacent upper edge portions of two adjacent folded surfaces are not neighboring, and a gap is formed between the two extensions.

Extensions formed on two adjacent lower edge portions of two adjacent folded surfaces are not neighboring, and a gap is formed between the two extensions.

Edge connections on head and tail portions of the shade wall are connected with each other via the velcro tapes and the magic stickers.

The technical proposal has the advantages that:

The lampshade provided by the invention has a simple structure, is convenient to use, and is difficult to break during the transportation and use. The greatest advantage is that the lampshade is convenient to assemble, disassemble and replace and meanwhile may be equipped with several shade walls which have different colors and styles and hence can be replaced according to user needs. Therefore, the lampshade is convenient and can be adapted to different consumers. Moreover, the lampshade provided by the invention is convenient in connection, assembly and the replacement of the shade wall by adoption of the velcro tapes and the magic stickers.

### BRIEF DESCRIPTION OF THE DRAWINGS

FIG. 1 is an exploded view of a lampshade provided by the invention;

FIG. 2 is a schematic diagram illustrating the folded state of a shade wall; and

FIG. 3 is a schematic diagram illustrating the state when the shade wall is not folded.

### DETAILED DESCRIPTION OF THE PREFERRED EMBODIMENTS

Detailed description will be given below to the invention with reference to the preferred embodiments.

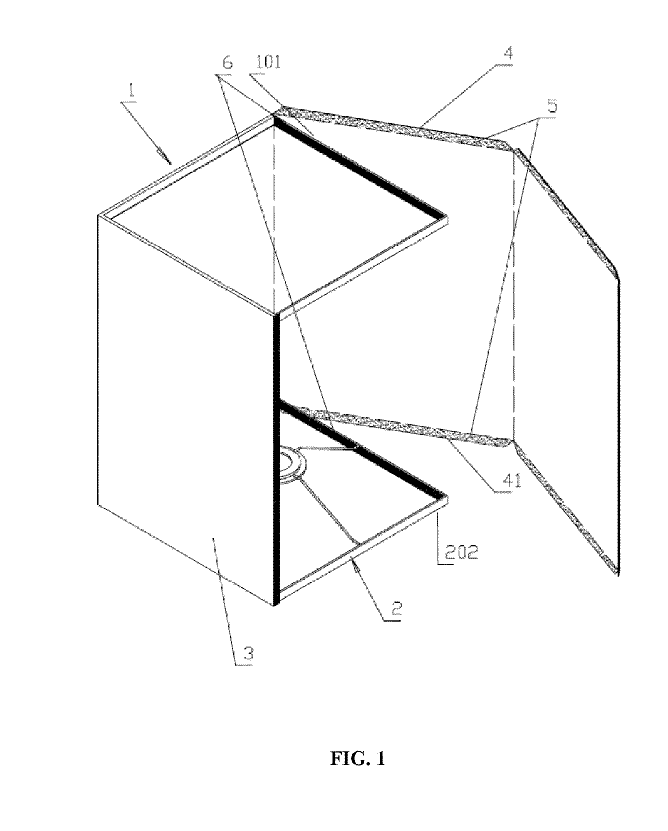

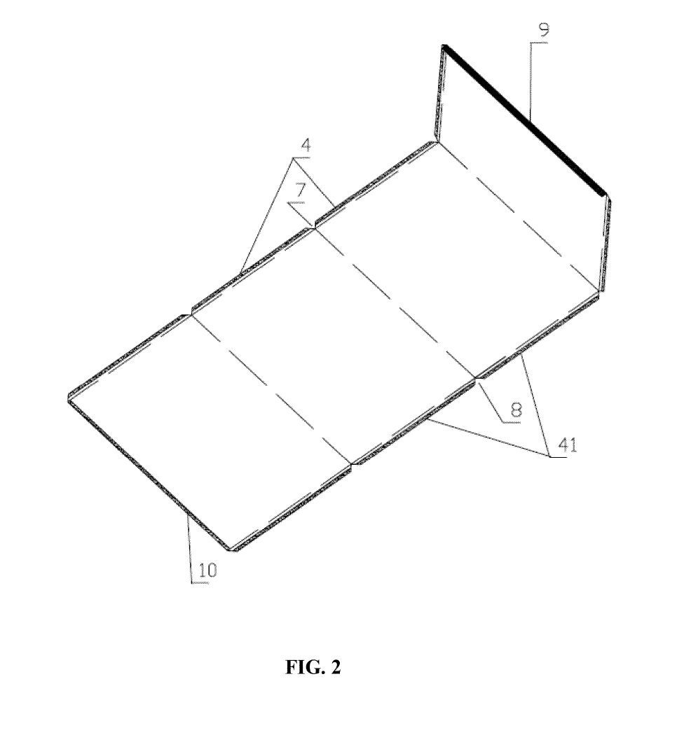

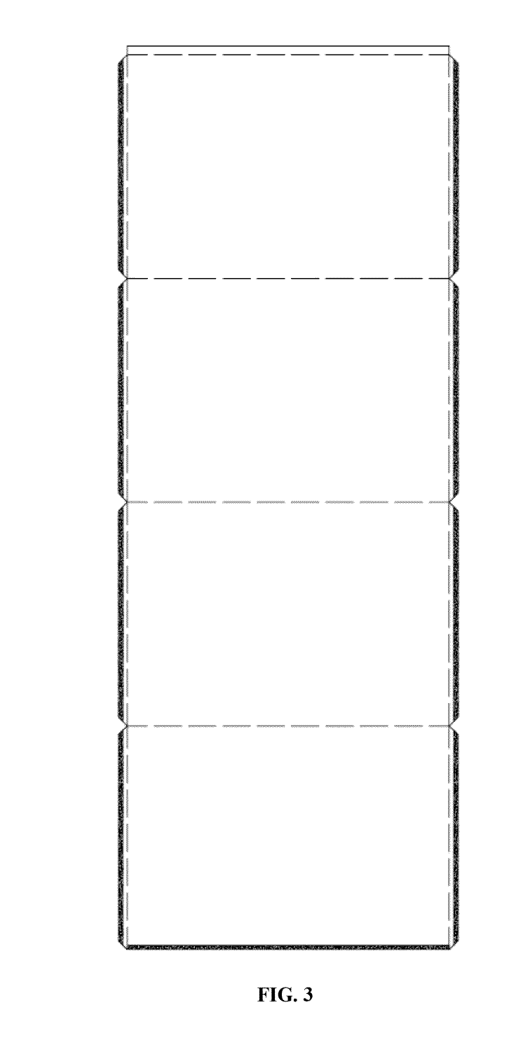

Embodiment 1: as illustrated in FIGS. 1 to 3, the lampshade comprises an upper frame 1, a lower frame 2 and a shade wall 3, wherein the upper frame 1 is disposed on the lower frame 2; the upper frame 1 and the lower frame 2 are respectively encircled by at least three borders, and four borders in the embodiment; the size and the shape of the upper frame 1 and the lower frame 2 are same; positions of various borders 101 in the upper frame 1 correspond to positions of various borders 202 in the lower frame 2 respectively; the shade wall 3 is rectangular; the shade wall 3 is folded to form folded surfaces of which the number is the same with that of the borders in the lower frame, and is folded to form four folded surfaces in the embodiment and folded along dotted lines as shown in the figure; the shade wall 3 is encircled on the outsides of the upper frame 1 and the lower frame 2; upper edge portions and lower edge portions of various folded surfaces are respectively and correspondingly encircled on the outsides of various borders 101 of the upper frame 1 and various borders 202 of the lower frame 2, and are respectively provided with extensions 4 and extensions 41; velcro tapes 5 are disposed on inner surfaces of various extensions; magic stickers 6 are disposed on inner side walls of various borders in the upper frame 1 and the lower frame 2; and after various extensions go around corresponding borders and are returned, the velcro tapes on respective inner surfaces are connected with the magic stickers 6 disposed on the corresponding borders. By utilization of the velcro tapes and the magic stickers, the lampshade is convenient in connection and assembly.

Extensions formed on two adjacent upper edge portions of two adjacent folded surfaces are not neighboring, and a gap 7 is formed between the two extensions 4. Due to the structure, when the extensions go around the corresponding borders and are returned, the two extensions are not connected with each other and hence are convenient to fold, and consequently the lampshade is convenient to assemble.

Extensions formed on two adjacent lower edge portions of two adjacent folded surfaces are not neighboring, and a gap 8 is formed between the two extensions 41. Due to the structure, when the extensions go around the corresponding borders and are returned, the two extensions are not connected with each other and hence are convenient to fold, and consequently the lampshade is convenient to assemble.

Edge connections on head and tail portions, namely a head portion 9 and a tail portion 10, of the shade wall are connected with each other via the velcro tapes and the magic stickers. Therefore, the lampshade is convenient in connection.

The foregoing is only the preferred embodiments of the invention and not intended to limit the invention. All the modifications and equivalent replacements and improvements made in accordance with the spirit and the principle of the invention should fall within the scope of protection of the invention.

What is claimed is:

1. A lampshade, comprising an upper frame, a lower frame and a shade wall, wherein the upper frame is disposed on the lower frame; the upper frame and the lower frame are respectively encircled by at least three borders; the size and the shape of the upper frame and the lower frame are same; positions of various borders in the upper frame and the lower frame correspond to each other respectively; the shade wall is rectangular, is folded to form folded surfaces of which the number is the same with that of the borders in the lower frame, and is encircled on the outsides of the upper frame and the lower frame; upper edge portions and lower edge portions of various folded surfaces are respectively and correspondingly encircled on the outsides of various borders in the upper frame and the lower frame, and are respectively provided with extensions; velcro tapes are respectively disposed on inner surfaces of various extensions; magic stickers are disposed on inner side walls of various borders in the upper frame and the lower frame; and after various extensions go around corresponding borders and are returned, the velcro tapes on respective inner surfaces are connected with the magic stickers disposed on the corresponding borders.

2. The lampshade according to claim 1, wherein extensions formed on two adjacent upper edge portions of two adjacent folded surfaces are not neighboring, and a gap is formed between the two extensions.

3. The lampshade according to claim 1, wherein extensions formed on two adjacent lower edge portions of two adjacent folded surfaces are not neighboring, and a gap is formed between the two extensions.

4. The lampshade according to claim 1, wherein edge connections at head and tail portions of the shade wall are connected with each other via the velcro tapes and the magic stickers.
